(19) United States
(12) Patent Application Publication
(10) Pub. No.: US 2018/0227824 A1
(43) Pub. Date: Aug. 9, 2018

(54) Method of Heterogeneous Network Mobility

(71) Applicant: MEDIATEK INC., Hsinchu (TW)

(72) Inventors: Yih-Shen Chen, Hsinchu (TW); Chia-Chun Hsu, Taipei City (TW); Per Johan Mikael Johansson, Kungsangen (SE)

(21) Appl. No.: 15/949,474

(22) Filed: Apr. 10, 2018

Related U.S. Application Data
(63) Continuation of application No. 14/808,189, filed on Jul. 24, 2015, now abandoned.
Application No. 14/808,189 is a continuation of application No. 13/569,303, filed on Aug. 8, 2012, now abandoned.
(60) Provisional application No. 61/522,572, filed on Aug. 11, 2011.

(51) Int. Cl. H04W 36/32; H04W 36/00

(52) U.S. Cl. CPC H04W 36/32; H04W 36/0083; H04W 36/245

(57) ABSTRACT

Methods for enhanced heterogeneous network mobility are proposed. In a first novel aspect, the cell size of a target cell is considered when determining the TTT value. In one embodiment, pico-specific Time-to-Trigger (TTT) value is configured. When the target cell to be measured is a picocell, pico-specific TTT value is applied. In a second novel aspect, precise mobility state estimation (MSE) is achieved by considering the effect of cell size. In one embodiment, when counting cell changes, a cell change to/from a small cell would be counted to lesser extent than a cell change between large cells. UE uses effective parameters for measurement evaluation, by applying better speed state estimation with speed scaling and by applying parameter differentiation that can be dependent on cell size.

### CROSS REFERENCE TO RELATED APPLICATION

This application is a continuation and claims priority under 35 U.S.C. § 120 from nonprovisional U.S. patent application Ser. No. 14/808,189, entitled “Method of Heterogeneous Network Mobility,” filed on Jul. 24, 2015, the subject matter of which is incorporated herein by reference. Application Ser. No. 14/808,189, in turn, claims priority under 35 U.S.C. § 120 from nonprovisional U.S. patent application Ser. No. 13/569,303, entitled “Method of Heterogeneous Network Mobility,” filed on Aug. 8, 2012, the subject matter of which is incorporated herein by reference. Application Ser. No. 13/569,303, in turn, claims priority under 35 U.S.C. § 119 from U.S. Provisional Application No. 61/522,572, entitled “Method for Heterogeneous Network Mobility,” filed on Aug. 11, 2011, the subject matter of which is incorporated herein by reference.

### TECHNICAL FIELD

The disclosed embodiments relate generally to heterogeneous network, and, more particularly, to enhanced heterogeneous network mobility.

### BACKGROUND

Developed by 3GPP, Long-Term Evolution (LTE) is the leading OFDMA wireless mobile broadband technology. LTE systems offer high peak data rates, low latency, improved system capacity, and low operating cost resulting from simple network architecture. An LTE system also provides seamless integration to older wireless network, such as GSM, CDMA and Universal Mobile Telecommunication System (UMTS). Current wireless cellular networks are typically developed and initially deployed as homogeneous networks using a macro-centric planned process. A homogeneous cellular system is a network of macro bases stations in a planned layout and a collection of user terminals, in which all the macro base stations have similar transmit power levels, antenna patterns, receiver noise floors, and similar backhaul connectivity to the packet core network.

Radio link throughput is approaching near optimal, as determined by information theoretical capacity limits. The next performance leap in wireless could come from advanced network deployment technology, such as heterogeneous network topology. LTE-Advanced (LTE-A) system improves spectrum efficiency by utilizing a diverse set of base stations deployed in a heterogeneous network fashion. Using a mixture of macro, pico, femto and relay base stations, heterogeneous networks enable flexible and low-cost deployments and provide a uniform broadband user experience. In a heterogeneous network, smarter resource coordination among base stations, better base station selection strategies and more advance techniques for efficient interference management can provide substantial gains in throughput and user experience as compared to a conventional homogeneous network.

In LTE/LTE-A systems, an evolved universal terrestrial radio access network (E-UTRAN) includes a plurality of evolved Node-Bs (eNBs) communicating with a plurality of mobile stations, referred as user equipments (UEs). Typically, each UE needs to periodically measure the received reference signal power and quality of the serving cell and neighbor cells and reports the measurement result to its serving eNB for potential handover or cell reselection. For example, Reference signal received power (RSRP) or Reference signal received quality (RSRQ) measurement of an LTE cell helps to rank among the different cells as input for mobility managements.

In practice, due to the varying nature of the radio signals, it is possible that what appears to be an increase or decrease of the received radio signal power or quality of a target neighbor cell due to UE movement is actually a fast signal fluctuation that lasts for only a short period of time. Such fast signal changes typically do not follow a long term average trend of the path loss and shadowing loss for a given UE movement pattern, and as a result, may create a series of handovers in a relatively short period of time. The series of handovers, namely “handover oscillation” or “ping-pong” effect, are often not beneficial or needed due to large signaling overhead in eNB-UE interface and eNB-eNB interface. Handover procedure triggered by those short-term measurement fluctuations obviously makes the system unstable and hard to manage.

Time-to-trigger (TTT) mechanism is introduced to mitigate the effect of measurement fluctuations, for connected mode UE mobility. TTT is defined as the minimum time that a handover condition has to be fulfilled for the handover to be triggered. The current TTT mechanism is designed for homogeneous network (i.e., macro cells) only. The TTT value can be scaled by “speed factor” (SF). SF is determined by UE speed state, which is calculated by mobility state estimation. If UE mobility state is high, TTT value is scaled down; on the contrary, if UE mobility state is low, TTT value is scaled up. Currently, the mobility state estimation is calculated without considering cell size information. Applying the current TTT mechanism to heterogeneous network deployment, higher handover failure rate would occur, e.g., too late handover for picocells. Possible enhancements for heterogeneous network mobility are sought.

### SUMMARY

It is an objective of the current invention to enhance the mobility performance in a heterogeneous cellular network, where large cells and small cells are mixed. By adapting to the situation, effective parameters are used by UE for measurement evaluation.

In a first novel aspect, the cell size of a target cell is considered when determining a Time-to-Trigger (TTT) value. A UE receives measurement configuration information transmitted from a serving base station. The measurement configuration information comprises a first TTT value and a second TTT value. The UE performs measurements over the serving cell and neighboring cells based on the measurement configuration information. The UE then applies the first TTT value if the measured cell belongs to a first cell category, and applies the second TTT value if the measured cell belongs to a second cell category. In one embodiment, the first cell category is macrocell and the second cell category is picocell.

In a second novel aspect, precise mobility state estimation (MSE) is achieved by considering the effect of cell size. A UE performs handover operations to/from a plurality of cells in a heterogeneous network. The UE stores handover statistics information, which comprises cell counts for cell changes to/from the plurality of cells resulting from the handover operations. The UE then performs mobility state estimation (MSE) based on the stored cell counts. Each cell count is applied by a weighting factor that reflects a cell size of a corresponding cell to/from which the UE performs handover. In one embodiment, when counting cell changes, a cell change to/from a small cell would be counted to lesser extent (e.g., scaled by a smaller weighting) than a cell change between large cells.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates a heterogeneous LTE/LTE-A network with enhanced mobility management in accordance with one novel aspect.

FIG. 2 is a simplified block diagram of a UE and an eNB for enhance mobility management in accordance with one novel aspect.

FIG. 3 illustrates a method of providing pico-specific TTT in accordance with one novel aspect.

FIG. 4 illustrates a method of precise mobility state estimation in accordance with one novel aspect.

FIG. 5 illustrates a method of UE-based mobility state estimation.

FIG. 6 illustrates a method of network-based mobility state estimation.

FIG. 7 is a flow chart of a method of providing pico-specific TTT in accordance with one novel aspect.

FIG. 8 is a flow chart of a method of precise mobility state estimation in accordance with one novel aspect.

### DETAILED DESCRIPTION

Reference will now be made in detail to some embodiments of the invention, examples of which are illustrated in the accompanying drawings.

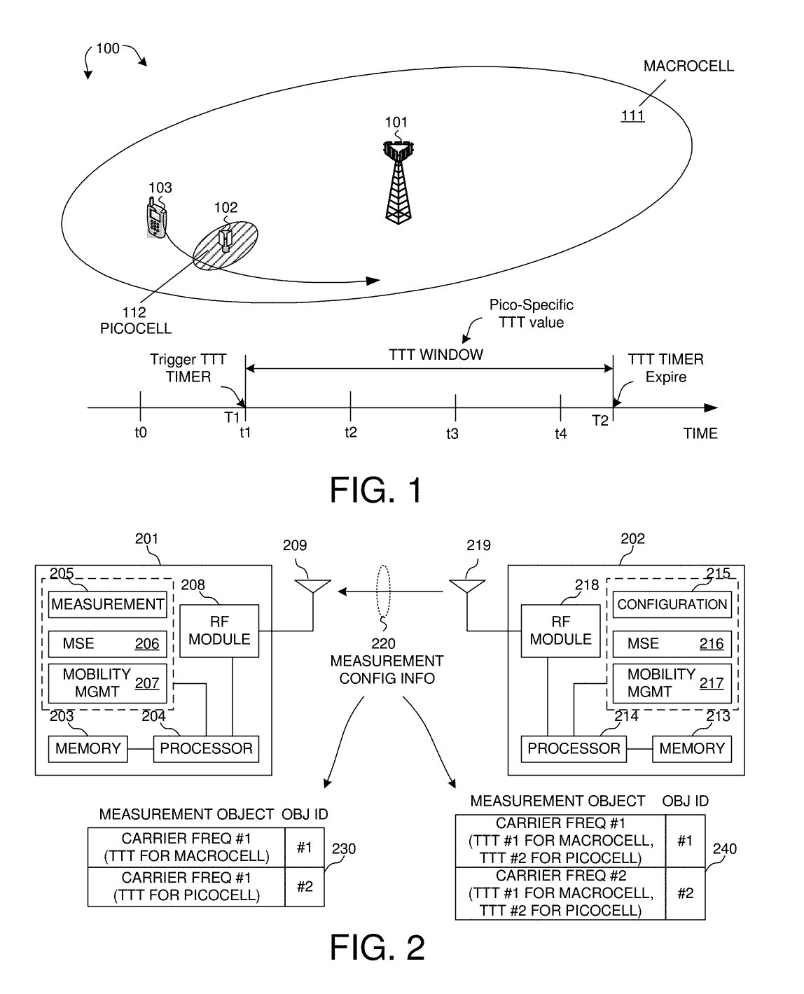

FIG. 1 illustrates a heterogeneous LTE/LTE-A network 100 with enhanced mobility management in accordance with one novel aspect. In LTE/LTE-A systems, an evolved universal terrestrial radio access network (E-UTRAN) includes a plurality of evolved Node-Bs (eNodeBs or eNBs) communicating with a plurality of mobile stations, referred as user equipments (UEs). Heterogeneous LTE/LTE-A network 100 comprises a macro eNB 101 serving a macrocell 111, a pico eNB 102 serving a picocell 112, and a UE 103. When UE 103 moves in the network, it may handover (HO) from one cell to another, depending on the radio signal power and quality of each cell with respect to the location of UE 103. Typically, UE 103 needs to periodically measure the received signal power and quality of the serving cell and neighbor cells and reports the measurement result to its serving eNB for potential handover or cell reselection. For example, Reference signal received power (RSRP) or Reference signal received quality (RSRQ) measurement of an LTE cell helps to rank between the different cells as input for mobility managements.

Due to the varying nature of the radio signals, Time-to-trigger (TTT) is introduced to mitigate the effect of measurement fluctuations. The TTT mechanism uses a predefined time window to smooth out the jitters, so that undesirable “handover oscillation” or “ping-pong” effect due to the measurement fluctuations can be reduced or eliminated. In the example of FIG. 1, UE 103 is served by serving macro base station eNB 101 in serving macrocell 111 initially. Pico eNB 102 is the neighbor base station that serves neighboring picocell 112. UE 103 periodically measures the RSRP/RSRQ of both the serving cell 111 and the neighbor cell 112 (e.g., at time instances t0, t1, t2, t3, and t4, etc.) At time instance t1, the measured RSRP/RSRQ of neighbor cell 112 is better than the measured RSRP/RSRQ of serving cell 111. UE 103 thus triggers a TTT timer at t1, which is also depicted as T1. Before the TTT timer expires, UE 103 continues to perform measurements over the serving cell 111 and the neighbor cell 112. If at any measurement time instance (e.g., t2/t3/t4), the measured RSRP/RSRQ of neighbor cell 112 becomes worse than the measured RSRP/RSRQ of serving cell 111, then the TTT timer is stopped and no handover request will be sent to serving eNB 101. On the other hand, if the measured RSRP/RSRQ of neighbor cell 112 continues to be better than the measured RSRP/RSRQ of serving cell 111 before the TTT timer expires (e.g., during the entire TTT window from time T1 to T2), then UE 103 may send the measurement results to serving eNB 101.

In current LTE/LTE-A systems, the TTT mechanism is designed for macrocells in a homogenous network. In other words, for each frequency carrier, there is only one TTT value defining the TTT window length. In a heterogeneous network, however, the cell size of a macrocell and the cell size of a picocell can be very different. For example, the size of a macrocell usually ranges from one to 20 kilo-meters, while the size of a picocell usually ranges from four to 200 meters. Therefore, if the same TTT value is applied for both macrocells and picocells, higher handover failure rate may occur. For example, if the TTT value is too big for a very small target picocell, then the handover may occur too late.

In accordance with one novel aspect, the cell size of a target cell is considered when determining the TTT value. By applying parameter differentiation, parameters such as the TTT window length that affects time-domain aspects of the measurement evaluation can be made to be dependent on cell size. For example, in addition to a normal TTT value for macrocell, a pico-specific TTT value can be predefined for picocell for UE measurement configuration.

FIG. 2 is a simplified block diagram of UE 201 and eNB 202 for measurement configuration in accordance with one novel aspect. UE 201 comprises memory 203, a processor 204, a measurement module 205, a mobility state estimation module 206, a mobility management module 207, and an RF module 208 coupled to an antenna 209. Similarly, eNB202 comprises memory 213, a processor 214, a configuration module 215, a mobility state estimation module 216, a mobility management module 217, and an RF module 218 coupled to an antenna 219. Alternatively, multiple RF modules and multiple antennas may be used for multi-carrier transmission with carrier aggregation. The various modules are function modules and may be implemented by software, firmware, hardware, or any combination thereof. The function modules, when executed by processors 204 and 214 (e.g., via program instructions contained in memory 203 and 213), interwork with each other to allow eNB 202 to configure measurement parameters for UE 201 such that UE 201 performs measurements and reports measurement results to eNB 202 for handover decisions.

Different carrier frequencies to be measured are specified by measurement objects. Typically, a measurement object contains measurement parameters including the frequency and bandwidth to be measured and the relevant measurement management parameters such as TTT, L3 filtering parameters, measurement gap, s-Measure, etc. As illustrated in FIG. 2, eNB 202 transmits measurement configuration information 220 to UE 201. The measurement configuration information contains different measurement objects for different carrier frequencies. In current LTE specification, only one measurement object is configured for one carrier frequency. In addition, one TTT value is applied to all the cells in one carrier frequency. In order to support pico-specific TTT, two embodiments are proposed.

In a first embodiment, as depicted by table 230, one carrier frequency can be configured with more than one measurement object. For example, carrier frequency #1 is configured with two measurement objects (OBJ#1 and OBJ#2). OBJ#1 is configured for macrocells with a macro-specific TTT value, and OBJ#2 is configured for picocells with a pico-specific TTT value. In this way, cells are divided into two cell categories based on cell size. Cells belonging to pico measurement object is distinguished from cells belong to macro measurement object by physical cell identity range (PCI range). Furthermore, within each measurement object, relevant measurement management parameters could be measurement object-specific to provide additional flexibility and the others could be common. For example, layer three (L3) filtering parameters could be different on different target cells, while measurement bandwidth could preferably be the same for all the measurements of a carrier frequency in order to simplify UE processing and UE measurements. In one example, the common measurement parameters are contained only in one measurement object.

In a second embodiment, as depicted by table 240, TTT is attached to PCI range (e.g., PCI split) in each measurement object. For example, carrier frequency #1 is configured with a first measurement object OBJ#1, and carrier frequency #2 is configured with a second measurement object OBJ#2. Within each measurement object, there are multiple TTT values, each configured for a different group of cells, e.g., one TTT value configured for one cell category and another TTT value configured for another cell category. In one example, TTT #1 is attached to PCIs belong to macrocells and TTT #2 is attached to PCIs belong to picocells. In another example, TTT #1 is attached to PCIs belong to macrocells and TTT #2 is applied to cells having other PCIs (without being attached to any PCI ranging).

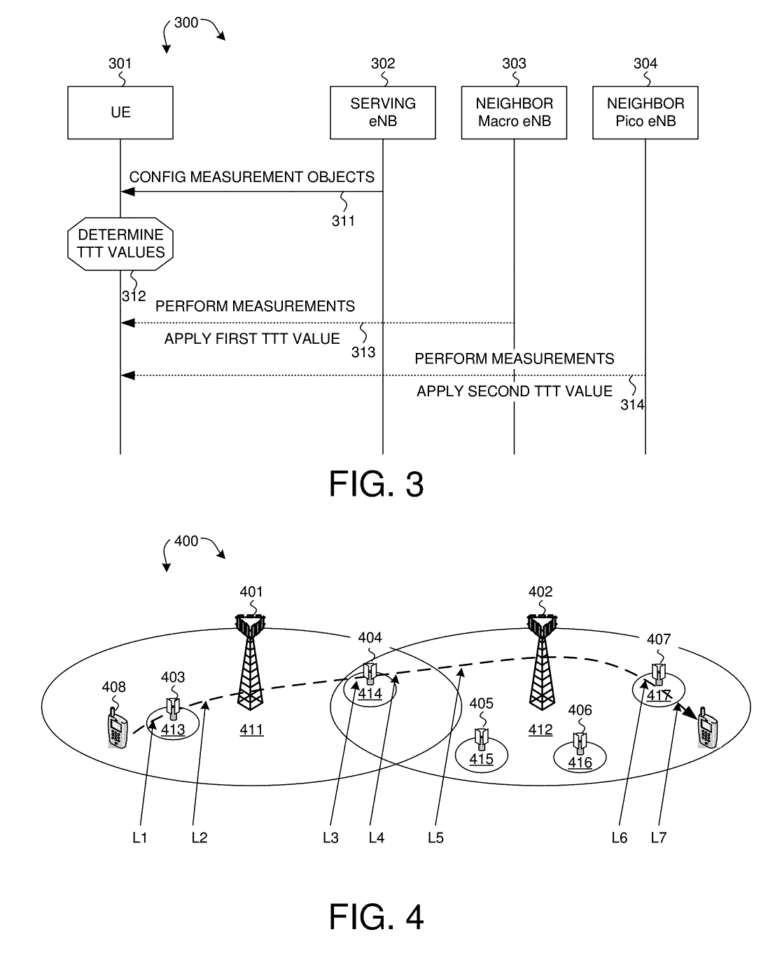

FIG. 3 illustrates a method of providing pico-specific TTT in accordance with one novel aspect. Mobile communication network 300 comprises a UE 301, a serving eNB 302, a first neighbor macro eNB 303, and a second neighbor pico eNB 304. In step 311, UE 301 receives measurement configuration information from serving eNB 302. The measurement configuration information comprises measurement objects, which in turn comprises different TTT values. Upon receiving the measurement configuration, UE 301 determines the TTT values for corresponding cell category (step 312). For example, a first TTT value is configured for macrocells over carrier frequency fl, and a second TTT value is configured for picocells over the same carrier frequency fl. In step 313, UE 301 performs measurements for a neighboring macrocell served by eNB 303 in carrier frequency fl. UE 301 applies the first TTT value for such measurement. In step 314, UE 301 performs measurements for a neighboring picocell served by eNB 304 in carrier frequency fl. UE 301 applies the second TTT value for such measurement.

The TTT mechanism can be scaled by a “speed factor” (SF). For example, a faster moving UE may apply a smaller TTT value, while a slower moving UE may apply a larger TTT value. This way, the TTT mechanism can be better adapted to UEs with different speed state. It is therefore important to be able to accurately determine SF, which is determined by UE speed state. The UE speed state is calculated by mobility state estimation (MSE). Currently, three speed states (High, Medium, and Low) are defined, and the MSE is calculated without considering cell size information. For example, the MSE is calculated based on the following equation:

MSE=number of cells (N_{C})/measurement time (T)

where
N_{C} is the cell counts of cell change
T is the total measurement time window

Without considering cell size information, however, the MSE is likely to be inaccurate, especially in a heterogeneous network. Study has shown that MSE becomes more unstable and unpredictable in HetNet environment. Inaccurate MSE in turn may cause inappropriate TTT value assignment and higher HO failure rate.

FIG. 4 illustrates a method of precise mobility state estimation in a mobile communication network 400 in accordance with one novel aspect. Mobile communication network 400 comprises a plurality of macro base stations eNB 401-402, a plurality of pico base stations eNB 403-407, and a UE 408. Macro eNB 401-402 serve macrocells 411-412 respectively, while pico eNB 403-407 serve picocells 413-417 respectively. UE 408 moves from location to location in network 400 during measurement time T. At various locations, UE 408 handovers from one cell to another cell. In the example of FIG. 4, the total number of handover cell counts is seven at location L1-L7 respectively for measurement time T. Under the current equation, the MSE for UE 408 is then 7/T.

More precise MSE can be achieved by correlating weighting parameters with MSE equations. The basic principle is to modify the current MSE equation by considering the effect of cell size. When counting cell changes from handover operation, e.g., a cell change to and/or from a small cell would be counted to a lesser extent than a cell change between large cells. There are four embodiments for UE-based precise mobility state estimation.

In a first embodiment, the mobility state estimation equation is:

MSE=[α*N_{CM}+β*N_{CP}]/measurement time (T) (1)

where
α is the weighting factor for macrocell
β is the weighting factor for picocell
N_{CM} is the cell counts of handover to macrocell
N_{CP} is the cell counts of handover to picocell

In the example of FIG. 4, let N_{CM} be the cell counts of handover to macrocell, and N_{CP} be the cell counts of handover to picocell. As a result, N_{CM}=4 (e.g., at locations L2, L4, L5, and L7), and N_{CP} 3 (e.g., at locations L1, L3, and L6). Applying equation (1) under the first embodiment, MSE=[4α+3β]/T. It can be seen that, by applying different weighting factors to cell counts for microcell and picocell (e.g., a is defined to be larger than β (α=1.2, β=0.8)), more precise MSE can be achieved by taking into account cell size effect. The cell size can be characterized by PCI split for picocell, or by the maximum transmit UL power, or by the transmission power of DL reference signal. The corresponding weighting factors can be pre-defined, broadcasted via System information block (SIB), or unicasted via radio resource control (RRC) message.

In a second embodiment, the mobility state estimation equation is:

MSE=[Σαᵢ]/measurement time (T) (2)

where
αᵢ is the weighting factor for cell i, and cell count occurs when UE changes cell to/from cell i

Under the second embodiment, the weighting factor αᵢ is dependent on the maximum transmit uplink (UL) power of cell i. For example, if the cell count occurs when UE 408 changes to picocell 413 at location L1, then α₁ is dependent on the maximum transmit UL power of picocell 413. Next, the cell count occurs when UE 408 changes to macrocell 411 at location L2, and α₂ is dependent on the maximum transmit UL power of macrocell 411, and so on so forth. Because each cell count is applied with a specific weighting factor proportional to the cell size, more precise mobility state estimation can be achieved. The dependency/proportional ratio of the weighting factors of the cell counts could be given by broadcasting (e.g., SIB) or by unicasting message (e.g., measurement configuration message), or could be estimated by UE itself.

In a third embodiment, the mobility state estimation equation is the same as equation (2), while the weighting factor αᵢ is dependent on the transmission power of the downlink (DL) reference signal. Similar to the second embodiment, for example, if the cell count occurs when UE 408 changes to picocell 413 at location L1, then α₁ is dependent on the transmission power of DL reference signal in picocell 413. Next, the cell count occurs when UE 408 changes to macrocell 411 at location L2, and α₂ is dependent on the transmission power of DL reference signal in macrocell 411, and so on so forth. Because each cell count is applied with a specific weighting factor proportional to the cell size, more precise mobility state estimation can be achieved. The dependency/proportional ratio of the weighting factors of the cell counts could be given by broadcasting or by unicasting message, or could be estimated by UE itself.

In a fourth embodiment, the mobility state estimation equation is the same as equation (2), while the weighting factor αᵢ is broadcasted by eNB (or unicasted by eNB if UE is in connected mode). Similar to embodiment 2 and embodiment 3, the weighting factor αᵢ is specific to each cell i and the cell count occurs when UE changes cell to cell i. For example, if the cell count occurs when UE 408 changes from cell 411 served by eNB 401 to cell 412 served by eNB 402 at location L5, then the weighting factor α₅ is broadcasted by eNB 402. Because each cell broadcasts its own weighting factor, specific consideration can be taken into account when counting cell change to the said cell (or from the said cell). If no weighting factor is broadcasted, then a weighting factor of one is assumed. On the other hand, if the weighting factor is equal to zero, then it means that the cell change is not counted. In one specific example, a Boolean variable B can be used to represent the weighting factors, B=1 indicates the cell change is counted and B=0 indicates the cell change is not counted. In one embodiment, the weighting factors of picocells are all zero so that the MSE function only accounts for handovers to macro cells. This specific weighting factor assignment is useful in heterogeneous network with densely deployed small cells.

Another UE-based method of achieving more precise MSE is via layer one (L1) absolute speed measurement. In general, UE speed-based thresholds are used to determine the mobility state. For example, if UE's speed is higher than x km/hr, then the UE is in high mobility state. In one embodiment, several thresholds are defined, where comparison to the thresholds would determine if mobility state is low, medium, or high. The benefit of using speed thresholds is that the signaling procedures could be independent of the speed estimation method. The speed thresholds would typically be configured using the same procedures where the current UE speed state estimation parameters are configured. Another benefit is that absolute speed measurement can reflect the real UE mobility behavior regardless of network deployment topology. The actual UE speed measurement can be done by Doppler spread estimation, or by GPS. Furthermore, the speed threshold based MSE may be associated with signaled UE capability information (e.g., whether UE has GPS capability). Strictly, UE capability may not be needed and be replaced by a priority rule such as “UE shall apply absolute speed estimation instead of speed estimation based on cell counting, if absolute speed thresholds are configured.” The benefits of having a UE capability would be that the network could know what kind of speed state estimation UE would apply, and could tailor the UE specific mobility configuration accordingly.

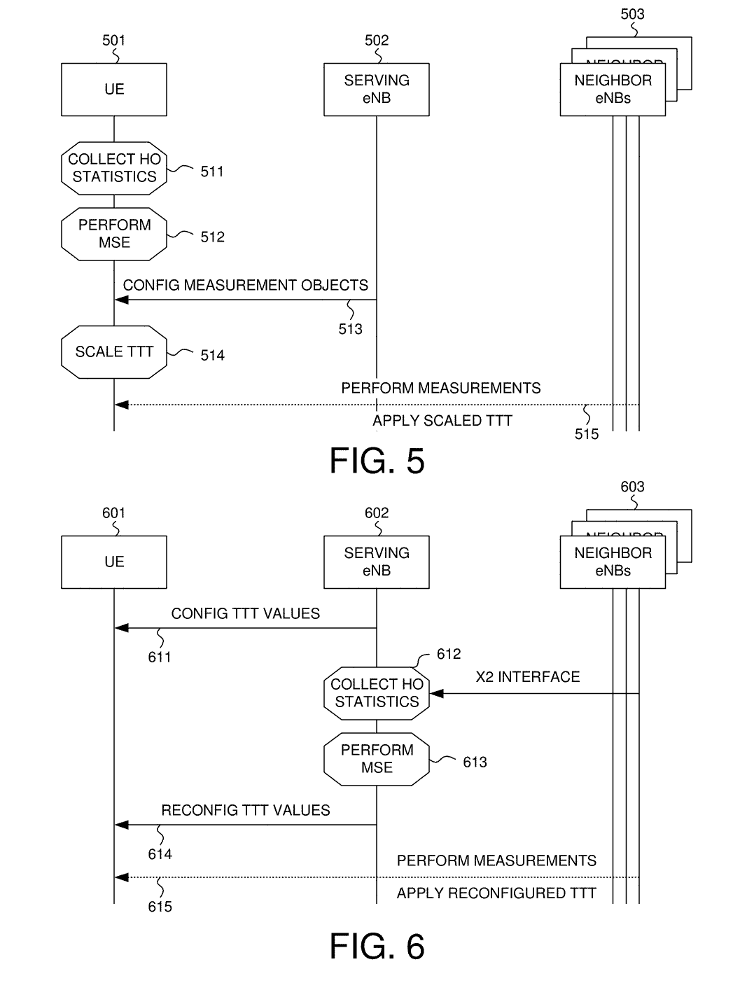

FIG. 5 illustrates a method of UE-based mobility state estimation in a heterogeneous network. In step 511, UE 501 collects history handover (HO) statistics, which includes handover cell counts of UE 501 changes to/from a cell. In step 512, UE 501 performs mobility state estimation based on the collected cell counts and by applying weighting factors reflecting cell sizes of the corresponding handover cells. In step 513, UE 501 receives measurement objects configured by serving eNB 502. The measurement objects contain different TTT values for different categories of cells having different cell sizes. In step 514, UE 501 may scale the TTT values based on the previously determined MSE. For example, if the determined MSE result indicates high UE mobility, then the TTT value is scaled down accordingly. In step 515, UE 501 performs measurements over serving cell and various neighboring cells, applying scaled TTT values based on the measured cell sizes.

FIG. 6 illustrates a method of network-based mobility state estimation in a heterogeneous network. While UE-based MSE mostly relies on the UE to perform mobility estimation, network-based MSE mostly relies on the eNB to perform mobility estimation. In step 611, eNB 602 configures TTT values for UE 601, which may use the configured TTT values for measurements. In step 612, eNB collects handover history, which may be forwarded from neighboring eNBs 603 via X2 interface. Because the cell size information is already known for eNBs, eNB 602 thus has the full knowledge to judge UE's mobility state in step 613. For example, eNB 602 may determine the MSE for UE 601 using equation (1) or equation (2) associated with the four embodiments illustrated above. In step 614, eNB 602 reconfigures TTT values for UE 601 based on the specific mobility state of UE 601 determined in step 613. In step 615, UE 601 performs measurements by applying the reconfigured TTT values.

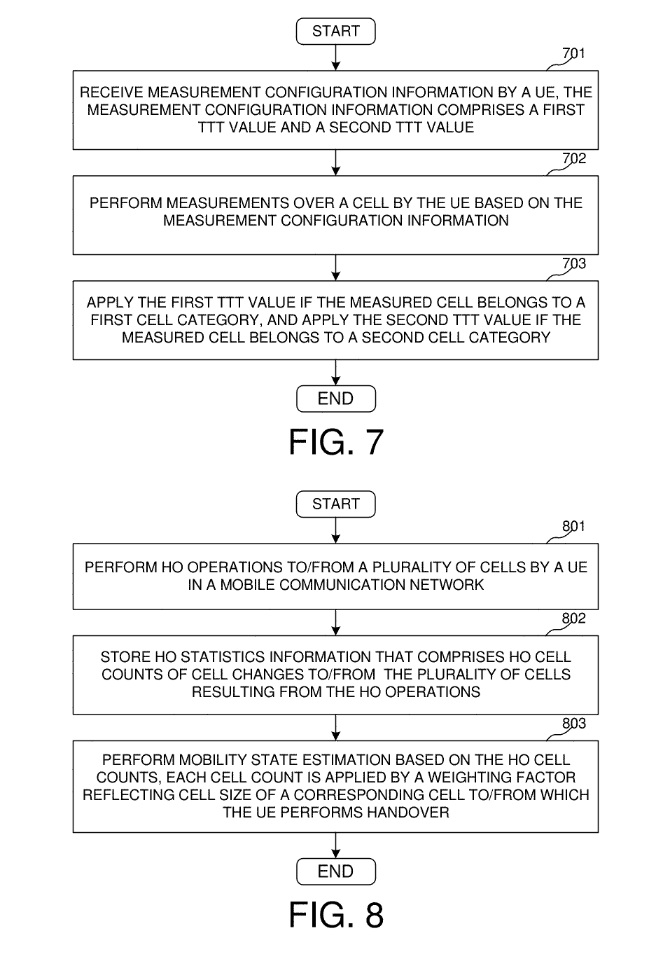

FIG. 7 is a flow chart of a method of providing pico-specific TTT in a heterogeneous network in accordance with one novel aspect. In step 701, a UE receives measurement configuration information transmitted from a serving base station. The measurement configuration information comprises a first TTT value and a second TTT value. In step 702, the UE performs measurements over the serving cell and neighboring cells based on the measurement configuration information. In step 703, the UE applies the first TTT value if the measured cell belongs to a first cell category, and applies the second TTT value if the measured cell belongs to a second cell category. In one embodiment, the first cell category is macrocell and the second cell category is picocell.

FIG. 8 is a flow chart of a method of precise mobility state estimation in a heterogeneous in accordance with one novel aspect. In step 801, a UE performs handover operations to/from a plurality of cells in the heterogeneous network. In step 802, the UE stores handover statistics information, which comprises cell counts for cell changes to/from the plurality of cells resulting from the handover operations. In step 803, the UE performs mobility state estimation (MSE) based on the stored cell counts. Each cell count is applied by a weighting factor that reflects a cell size of a corresponding cell to/from which the UE performs handover.

Note that for 3GPP systems, scaling of mobility parameters based on cell size is applicable not only for connected mode mobility, but also for idle mode mobility, affecting hysteresis and Treselection. Although connected mode mobility and its parameters such as TTT are usually of higher importance than idle mode (because connected mode mobility has more direct impact on service), the improvements proposed in this application and their benefits are valid also for idle mode mobility and parameters such as Treselection and hysteresis (Qhyst). For example, Treselection is the cell reselection time—cell reselection is executed once the Treselection timer expires. Thus, Treselection can be scaled based on cell size similar to TTT. Likewise, Qhyst is the hysteresis value for cell ranking criteria—Higher Q value indicates higher cell ranking. Therefore, Qhyst can be weighted based on cell size similar to MSE. The scaled idle mode mobility parameters are beneficial for power saving operation by reducing cell reselection rate.

Heterogeneous network is a concept to integrate more than one cell type in a network. Macro cell and other cell types, such as micro cells, pico cells, femto cells, hot-spot cell, small cells, can be deployed together. Hybrid of macro and pico as a heterogeneous network is one of the examples. There are many other heterogeneous network topologies. For example, in another embodiment, macro cells can be deployed and accompanied with many femto cells to extend indoor coverage.

Although the present invention is described above in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method, comprising:
performing handover (HO) operations to/from a plurality of cells by a user equipment (UE) in a mobile communication network;
receiving one or more cell specific weighting factors of one or more corresponding neighboring cells, wherein each weighting factor indicates a speed factor;
performing mobility state estimation (MSE) based on the speed of the UE; and
selecting a HO target cell based on the MSE and the weighting factors according to a predefined speed-based selecting rule.

2. The method of claim 1, wherein the predefined speed-based selecting rule requires if the MSE indicates a high-speed UE a cell with the weighting factor indicating a high-speed has higher priority, otherwise, a cell with the weighting factor indicating a high-speed has lower priority.

3. The method of claim 1, wherein the weighting factors for each cell are obtained from broadcasting or unicasting message.

4. The method of claim 3, wherein the weighting factors are broadcasted in system information block (SIB).

5. The method of claim 1, wherein the MSE is based on a HO cell counts and the weighting factors, and wherein the UE stores HO cell counts of cell changes to/from the plurality of cells resulting from the handover operations.

6. The method of claim 1, wherein the MSE is based on an absolute speed measurement by the UE.

7. A user equipment (UE), comprising:
a radio frequency (RF) transceiver that transmits and receives wireless signals in a wireless network;
a handover (HO) circuit that performs HO operations to/from a plurality of cells by a user equipment (UE) in a mobile communication network;
a weighting factor circuit that receives one or more cell specific weighting factors of one or more corresponding neighboring cells, wherein each weighting factor indicates a speed factor;
a mobility state estimation (MSE) circuit that performs a MSE based on the speed of the UE; and
a target cell circuit that selects a HO target cell based on the MSE and the weighting factors according to a predefined speed-based selecting rule.

8. The UE of claim 7, wherein the predefined speed-based selecting rule requires if the MSE indicates a high-speed UE a cell with the weighting factor indicating a high-speed has higher priority, otherwise, a cell with the weighting factor indicating a high-speed has lower priority.

9. The UE of claim 7, wherein the weighting factors for each cell are obtained from broadcasting or unicasting message.

10. The UE of claim 9, wherein the weighting factors are broadcasted in system information block (SIB).

11. The UE of claim 7, wherein the MSE is based on a HO cell counts and the weighting factors, and wherein the UE stores HO cell counts of cell changes to/from the plurality of cells resulting from the handover operations.

12. The UE of claim 7, wherein the MSE is based on an absolute speed measurement by the UE.

13. A method, comprising:
sending one or more cell specific weighting factors of one or more corresponding neighboring cells by a base station, wherein each weighting factor indicates a speed factor;
receiving mobility state estimation (MSE) from one or more user equipment (UE) indicating the speed of the UE; and
selecting a HO target cell based on the MSE and the weighting factors according to a predefined speed-based selecting rule.

14. The method of claim 13, wherein the predefined speed-based selecting rule requires if the MSE indicates a high-speed UE a cell with the weighting factor indicating a high-speed has higher priority, otherwise, a cell with the weighting factor indicating a high-speed has lower priority.

15. The method of claim 13, wherein the weighting factors for each cell are transmitted using broadcasting or unicasting message.

16. The method of claim 13, wherein the weighting factors are broadcasted in system information block (SIB).

17. The method of claim 16, wherein the MSE of each UE is based on a HO cell counts of corresponding UE and weighting factors, and wherein the corresponding UE stores HO cell counts of cell changes to/from the plurality of cells resulting from the handover operations.

18. The method of claim 13, wherein the MSE of a UE is based on an absolute speed measurement by a corresponding UE.
